(19) United States
(12) Patent Application Publication
(10) Pub. No.: US 2010/0246861 A1
(43) Pub. Date: Sep. 30, 2010

(54) SMALL-SIZED SOUND RECEIVER FOR PRODUCING BODY-SENSING VIBRATION

(76) Inventors: Sung-Moon HAN, Seoul (KR); Hyeong-Yong Hwang, Incheon (KR)

Correspondence Address: CHRISTOPHER PAUL MITCHELL, 888 16TH ST., NW, SUITE 800, WASHINGTON, DC, 20006, US

(21) Appl. No.: 12/600,259

(22) PCT Filed: Jul. 12, 2007
(86) PCT No.: PCT/KR2007/003368

§ 371 Date: Jun. 14, 2010

(30) Foreign Application Priority Data
May 15, 2007 (KR) 10-2007-0047218

(51) Int. Cl. H04R 1/10; H04B 7/00

(52) U.S. Cl. 381/151; 455/41.3

(57) ABSTRACT

Disclosed is a small-sized sound receiver for producing body-sensible vibration, and more particularly to a small-sized sound receiver for producing body-sensible vibration, which has a structure for bone-conduction so that the receiver can implement not only a function of a common small-sized sound receiver but also sensing of various sounds and various body-sensible vibrations, such as body-sensible vibration and bone-conduction sound, or the like.

### TECHNICAL FIELD

The present invention relates to a small-sized sound receiver for producing body-sensible vibration, and more particularly to a small-sized sound receiver for producing body-sensible vibration, which has a structure for bone-conduction so that the receiver can implement not only a function of a common small-sized sound receiver but also body-sensible vibration and bone-conduction sound.

### BACKGROUND ART

A small-sized sound receiver refers to an earphone or a headphone, which has a small-sized built-in speaker and thus has a size and a shape suitable for putting-on within an ear or attachment to an external ear, and directly outputs sound signals received from a main body of a sound playing device, such as an MP3 player, to the external ear. The small-sized sound receiver is of high utility value as a portable device due to its compactness and convenience of use.

However, a conventional small-sized receiver includes a vibration plate (diaphragm), which has a small-sized area and thus has a weak output. Therefore, con-ventional small-sized receiver cannot implement an auditory pitch corresponding to an auditory sense of a low band.

Further, upon listening for a long time or in a noisy environment in which sound volume is required to be turned up, the conventional small-sized receiver may put stress on the auditory organ, or cause big damage to it.

Accordingly, there have been a high-power vibration earphone and a headphone developed in order to support vibration capable of replacing sounds. However, the con-ventional vibration earphone or headphone has a structure corresponding to nothing but a simple integration of a sound generating unit with a vibration generating unit. In this respect, there is still a request for a great study of a structure which can effectively generate and transfer vibration while blocking interference between vibrations under limitation of a space of the small-sized sound receiver.

### DISCLOSURE OF INVENTION

### Technical Problem

The present invention has been made in order to overcome the problems that the conventional small-sized sound receiver is limited for utilization due to dissatisfaction of its auditory sound, and an object of the present invention is to provide a small-sized sound receiver for producing body-sensible vibration, which can provide a broadband auditory effect and body-sensible vibration and can be economically implemented.

### Technical Solution

In accordance with an aspect of the present invention, there is provided a small-sized sound receiver for producing body-sensible vibration, including: a sound generating unit having a shape which can be inserted into or attached to an external ear part and vibrating a diaphragm based on a sound signal received from a main body of a sound playing device so as to output a sound; a vibration generating unit having a linear vibration structure; a housing for encasing and protecting the sound generating unit and the vibration generating unit, the housing comprising a housing portion surrounding the vibration generating unit; an intermediate controlling unit positioned between the main body and the sound generating unit and controlling the sound signal input to the sound generating unit; and a vibration transfer unit connected to the housing portion surrounding the vibration generating unit, the vibration transfer unit being in direct contact with the external ear part, wherein the intermediate controlling unit divides one signal channel output from the main body into two signal channels and controls a size of an output signal, and one of the divided two signal channels is connected to the sound generating unit and the other signal channel is connected to the vibration generating unit, so that the intermediate controlling unit controls the size of the output signal of either or both of the two signal channels.

### Advantageous Effects

According to the present invention, a broadband auditory pitch and woofer vibration can be implemented by a small-sized sound receiver capable of being inserted into or attached to an external ear part so it overcomes limitation on an auditory pitch of a conventional small-sized sound receiver and it is possible to enjoy an auditory pitch of a high-quality speaker in a economical and convenient manner.

Further, it is easy to shift a mode by using a conventional volume controlling lever so that there is an advantage that only a small-sized sound receiver makes it possible to selectively enjoy various auditory pitches and bodily sensation in a mode such as a sound plus body-sensible vibration mode, a bone-conduction mode, a simple sound mode, or the like.

### BRIEF DESCRIPTION OF THE DRAWINGS

The foregoing and other objects, features and advantages of the present invention will become more apparent from the following detailed description when taken in conjunction with the accompanying drawings in which:

FIG. 1 illustrates an exemplary embodiment of a small-sized sound receiver according to the present invention;

FIGS. 2A to 2D illustrate other exemplary embodiments of a small-sized sound receiver according to the present invention;

FIG. 3 illustrates an exemplary view showing a small-sized sound receiver connected with a main body device of a small-sized sound receiver according to the present invention; and

FIG. 4 illustrates an exemplary view showing a circuit for controlling a sound signal of a small-sized sound receiver according to the present invention.

### MODE FOR THE INVENTION

Hereinafter, exemplary embodiments of the present invention will be described with reference to the accompanying drawings.

A core technical idea of the present invention is to provide a vibration structure of a small-sized sound receiver inserted into or attached to an external ear or a peripheral part of an external ear (hereinafter, called an external ear part), by which a user can enjoy, even with a low power, an effect of a body-sensible vibration as powerful as the power output from an amplifier. Such a vibration can make up for a bass band of the small-sized sound receiver by the effect of bone-conduction, and dramatically improve an auditory pitch by the effect of body-sensible vibration.

In more specific, according to the present invention, a vibration generating unit having a bone-conduction structure is employed in addition to the conventional small-sized sound receiver, so that it is possible to delicately process the vibration. A vibration transmission structure is accomplished by connecting a vibration transfer unit made of solid material which contacts the external ear part with a housing portion of the vibration generating unit. An intermediate controlling unit is provided between the housing and a main body, and an input channel of a sound generating unit and the vibration generating unit are separated from each other by two channels output from the intermediate controlling unit. Further, the intermediate controlling unit controls signals output to the two channels. At this time, the intermediate controlling unit controls either or both of the two channels.

Accordingly, a device according to the present invention can maintain compatibility with the conventional device and delicately control the sound and a level of the vibration through the intermediate controlling unit, so that a user can selectively enjoy sensing of various sounds and various body-sensible vibrations.

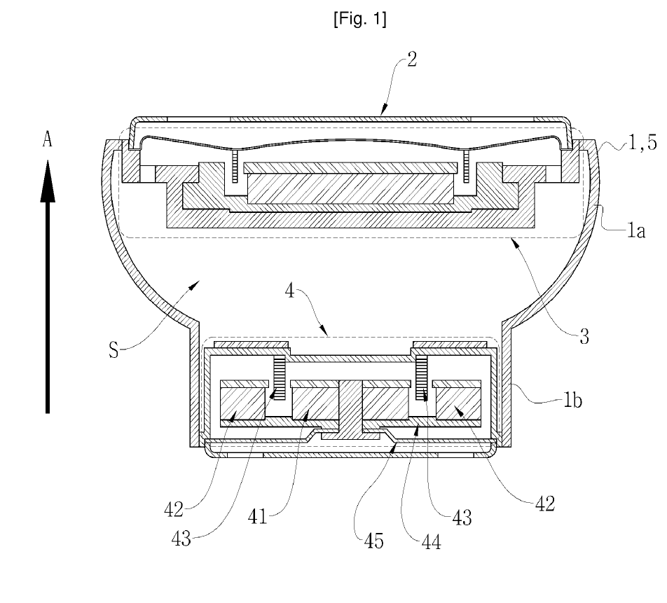

FIG. 1 illustrates an exemplary embodiment of a small-sized sound receiver for producing body-sensible vibration according to the present invention. A sound generating unit and a vibration generating unit are mounted on a single housing, which can be inserted or attached in an A direction.

The housing 1 includes a cover 2 having pores formed at a portion which contacts an external ear, has a shape capable of being inserted into or attached to an external ear part, and includes the sound generating unit 3 inside thereof. The sound generating unit 3 can use anything that has a small-sized speaker structure employed in the conventional small-sized sound receiver.

The sound generating unit 3 is mounted in such a manner that the sound generating unit 3 faces an inner surface of the cover 2 and outputs sound generated by the diaphragm through the cover 2. Based on a sound signal input from a main body, a vibration coil vibrates the diaphragm, so as to output a sound.

A vibration generating unit 4 mounted spacing apart from the sound generating unit 3 can be applied to anything having a linear vibration structure which is a basic of a bone-conduction structure. Therefore, in the present invention, it is a key to provide a delicate and strong vibration force.

In the present embodiment, a bone-conduction structure employs a magnet as a vibrating weight, and has a duplex magnet structure including a central magnet 41 shaped like an integral cylinder and an outer magnet 42 shaped like a ring, which surrounds and is spaced apart from the central magnet 41.

The vibration coil 43 is positioned between the central magnet 41 and the outer magnet 42 so as to generate the vibration of the magnet, and the central magnet 41 and the outer magnet 42 are fixed by a protecting member 44 supporting them at lower surfaces thereof.

Further, one end of a leaf spring 45 which is a key of transmitting a vibration force is assembled with an inner side of the housing, and the other end of the leaf spring 45 is assembled with centers of the protecting member 44 and the central magnet 41 so as to maximize a width of the vibration.

A structure of the vibration generating unit 4 has superior vibration reactivity so as to generate sufficient vibration force even in a weak sound signal, so that it can provide effects of the bone-conduction and the body-sensible vibration. Further, the power consumption is low, so that it is greatly effective on making the device in a compact size and decreasing production cost.

In addition, the vibration transfer unit can be implemented in various ways, in specific, by modifying the duplex magnet structure, it is possible to adopt one central magnet and to place a bent magnetic material extending from the protecting member supporting the central magnet, instead of the outer magnets.

In order to transfer the vibration of the vibration generating unit to the external ear part, the vibration transfer unit attached to the external ear part should connect with a housing portion 1b of the vibration generating unit.

In the present embodiment, the housing portion of a sound generating unit is integrally connected to the housing portion of the vibration generating unit. Accordingly the housing portion 1a of the sound generating unit being in direct contact with the external ear part serves as the vibration transfer unit, and the housing portion 1b of the vibration generating unit is connected with the housing portion 1a of the sound generating unit, so that the vibration is transferred to the external ear part.

If the sound generating unit and the vibration generating unit are driven simultaneously as the present invention, in order to improve the sound quality and provide an effect of the intended bone-conduction body-sensible vibration, a structure capable of preventing interference of the vibration force occurring between the sound generating unit and the vibration generating unit should be provided.

According to the exemplary embodiment of FIG. 1, it would be known that a separating space S is positioned between the sound generating unit and the vibration generating unit so that it prevents the direct interference between them.

As a result of a test, it is okay if a separating distance of the separating space can decrease the magnetic force of the vibration generating unit by at least 50%.

However, the separating space between the two units is not always indispensable when the sound generating unit and the vibration generating unit are mounted in the same space. By placing the sound generating unit and the vibration generating unit to have opposite polarities, it is also possible to prevent the interference between them.

Therefore, the above embodiment can be also applied to the case where the sound generating unit and the vibration generating unit are individually mounted in a separated housing.

The vibration transfer unit 5 is connected to the housing portion of the vibration generating unit and is attachable to the external ear part, which can be implemented in various ways. Therefore, if the housing portion of the sound generating unit 3 is connected to the housing portion of the vibration generating unit, the housing portion of the sound generating unit serves as the vibration transfer unit. If the housing portion of the sound generating unit 3 is separated from the housing portion of the vibration generating unit, the vibration transfer unit should be separately formed. Then, the vibration transfer unit is connected to the housing portion of the vibration generating unit, is attached to the external ear, and supports the housing portion of the vibration generating unit.

Therefore, the vibration transfer unit can be made from any material, which can transfer the vibration as it is without absorbing the vibration and has a force for maintaining its shape. The vibration transfer unit should be made from a material which can maintain a bond-conduction sound pressure generated from the vibration generating unit by at least 50%, such as synthetic resins used for the housing, metal materials, or the like.

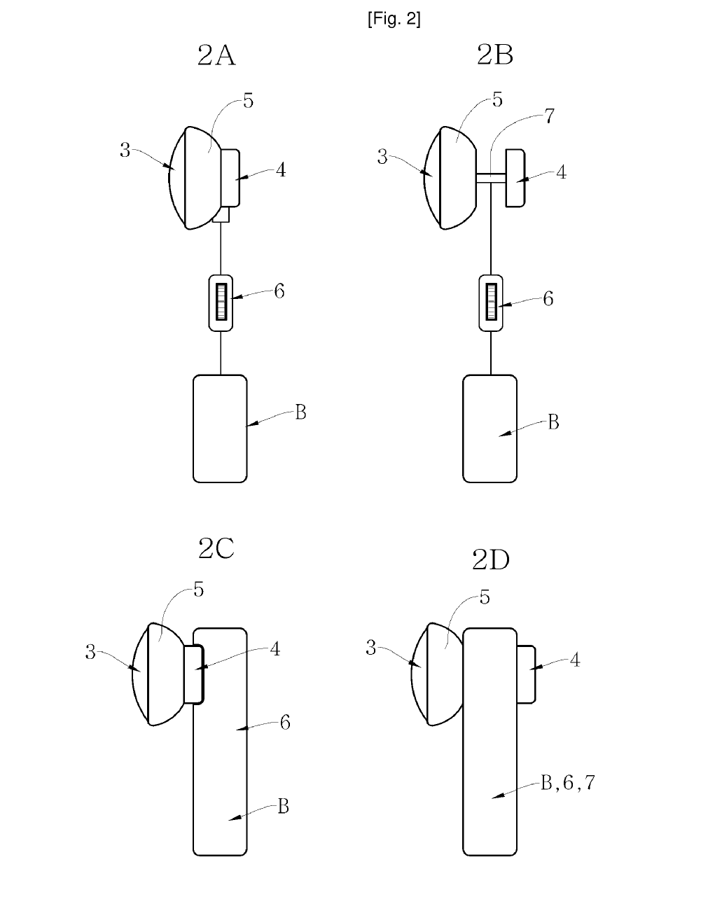

The mounting structure of the sound generating unit 3 and the vibration generating unit 4 and the structure of the vibration transfer unit 5 can be implemented in various ways as shown in FIGS. 2A to 2D in addition to the exemplary embodiment of FIG. 1. Therefore, the housing portion of the sound generating unit should have an at least structure that can be inserted into the ear or attached to the external ear part. However, it is sufficient if the only vibration generating unit has a structure which can transfer the vibration through the vibration transfer unit which is connected to the housing portion of the vibration generating unit and is attached to the external ear part.

In the case of FIG. 2A, the housing portion of the sound generating unit 3 is in contact with the housing portion of the vibration generating unit 4 and the housing portion of the sound generating unit serves as the vibration transfer unit 5, and then the vibration of the vibration generating unit 4 is transferred from its housing portion to the housing portion of the sound generating unit 3, so the vibration is transferred to the auditory organ.

In the case of FIG. 2B, the housing portion of the sound generating unit is spaced apart from the housing portion of the vibration generating unit, and the housing portion of the sound generating unit is connected to the housing portion of the vibration generating unit by a bridge 7. According to FIG. 2A, the housing portion of the sound generating unit performs a function of the vibration transfer unit 5 so that the vibration of the vibration generating unit 4 is transferred from the housing portion of the vibration generating unit to the housing portion of the sound generating unit 3 attached to the external ear part through the bridge, so as to transfer the vibration to the auditory organ.

In the case of FIG. 2C, a main body is a Bluetooth headset, and the housing portion of the sound generating unit is assembled with the housing portion of the vibration generating unit and then they are mounted in the Bluetooth headset. In this case, similar to that of the FIG. 2A, the vibration of the vibration generating unit 4 is transferred from the housing portion of the vibration generating unit to the housing portion of the sound generating unit 3 attached to the external ear part so that the vibration is transferred to the auditory organ. Accordingly, the housing portion of the sound generating unit can perform a function as the vibration transfer unit 5.

In the case of FIG. 2D, a main body is also a Bluetooth headset, and the housing portion of the sound generating unit and the housing portion of the vibration generating unit are separately mounted. The vibration of the vibration generating unit 4 is transferred from the housing portion of the vibration generating unit to the housing portion of the sound generating unit 3 attached to the external ear part through the Bluetooth headset serving as the bridge 7, so that the vibration is transferred to the auditory organ. Accordingly, the housing portion of the sound generating unit can also perform a function as the vibration transfer unit 5.

As noted from the above description, the vibration transfer unit can be implemented in various ways according to the assembling relation between the sound generating unit and the vibration generating unit, and the determination if such implementation belongs to the scope of the invention depends on a determination if it belongs to the technical idea of the invention described above.

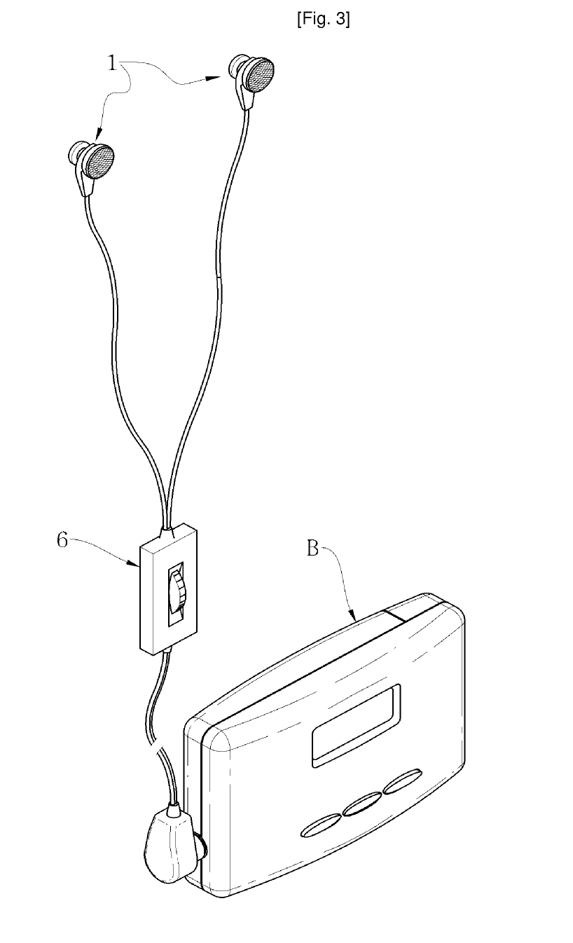

As shown in FIG. 3, the intermediate controlling unit 6 is provided between a main body B and the housing, and the intermediate controlling unit 6 includes a signal resistor as a conventional sound controlling lever capable of controlling the size of the output signal.

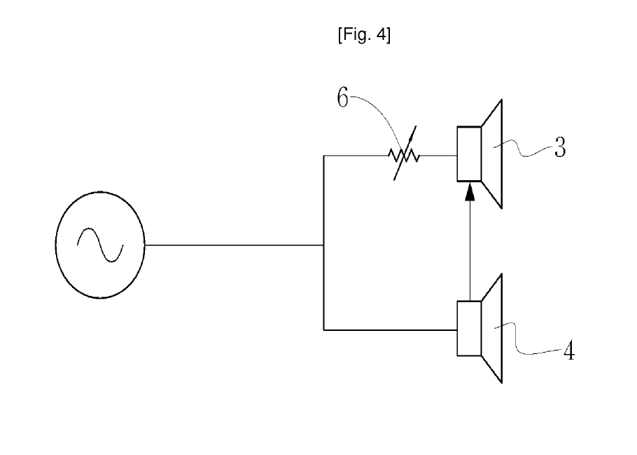

The sound generating unit and the vibration generating unit of the present invention are separately formed, and thus an input terminal of the sound signal is also separately formed. As shown in FIG. 4, a signal input from the main body is divided into two channels by the intermediate controlling unit 6 so as to transmit the divided signal to the sound generating unit and the vibration generating unit.

FIG. 4 is an exemplary embodiment of a configuration that the intermediate controlling unit controls a size of the signal of the sound generating unit. The intermediate controlling unit can be configured to control the signal of either of both of the sound generating unit and the vibration generating unit based on the necessity of controlling the size of the signal.

In the case of controlling the signal as shown in FIG. 4, if the intermediate controlling unit 6 is appropriately controlled in a direction of increasing the sound volume, the volume of a current of the sound signal input to the sound generating unit 3 is controlled, so that a user can enjoy the sound together with the body-sensible vibration.

However, if the intermediate controlling unit 6 is controlled in a counter direction and the volume is then completely turned down, the sound signal input to the sound generating unit 3 is interrupted and only the vibration generating unit 4 is operated, so that the apparatus according to the present invention can be utilized as the small-sized sound receiver having only the bone-conduction function.

Further, if the sound volume of the main body is turned down and then the intermediate controlling unit 6 is controlled to the maximum sound volume, the vibration of the vibration generating unit offsets by the frequency of the sound generating unit so that a user cannot feel the vibration. Therefore, a sound mode allowing a user to listen to sound only is implemented like a common small-sized sound receiver.

As described above, by controlling the sound generating unit and the vibration generating unit having separated input signal channels in an analog manner through the intermediate controlling unit 6 like the conventional sound controlling lever, it is possible to achieve the main effect of the invention, that is, switching between \textcircled{1} a sound plus body-sensible vibration mode, \textcircled{2} a bone-conduction mode, and \textcircled{3} a sound mode. In addition, a user can enjoy the auditory pitch of various spectrums by delicately controlling the sound and the level of the vibration.

Although several exemplary embodiments of the present invention have been described for illustrative purposes, those skilled in the art will appreciate that various modifications, additions and substitutions are possible, without departing from the scope and spirit of the invention as disclosed in the accompanying claims.

1. A small-sized sound receiver for producing body-sensible vibration, comprising:
a sound generating unit having a shape which can be inserted into or attached to an external ear part and vibrating a diaphragm based on a sound signal received from a main body of a sound playing device so as to output a sound;
a vibration generating unit having a linear vibration structure;
a housing for encasing and protecting the sound generating unit and the vibration generating unit, the housing comprising a housing portion surrounding the vibration generating unit;
an intermediate controlling unit positioned between the main body and the sound generating unit and controlling the sound signal input to the sound generating unit; and
a vibration transfer unit connected to the housing portion surrounding the vibration generating unit, the vibration transfer unit being in direct contact with the external ear part,
wherein the intermediate controlling unit divides one signal channel output from the main body into two signal channels and controls a size of an output signal, and one of the divided two signal channels is connected to the sound generating unit and the other signal channel is connected to the vibration generating unit, so that the intermediate controlling unit controls the size of the output signal of either or both of the two signal channels.

2. The small-sized sound receiver for producing body-sensible vibration according to claim 1, wherein the vibration generating unit comprises:
a duplex structure magnet including an integral central magnet and an outer magnet spaced apart from each other, the integral central magnet serving as a vibration weight, the outer magnet surrounding the integral central magnet;
a protecting member supporting the central magnet and the outer magnet;
a leaf spring serving as an elastic body, the leaf spring having one end assembled with an inner side of the housing and another end assembled with centers of the protecting member and the central magnet; and
a vibration coil shaped like a ring and positioned between the central magnet and the outer magnet.

3. The small-sized sound receiver for producing body-sensible vibration according to claim 1, wherein the housing portion of the sound generating unit is integrally connected to the housing portion of the vibration generating unit, so that the housing is an integral housing comprising the housing portion of the sound generating unit and the housing portion of the vibration generating unit, the sound generating unit and the vibration generating unit are mounted in the integral housing while being spaced apart from each other or having opposite polarities, and the vibration transfer unit is a part of the integral housing.

4. The small-sized sound receiver for producing body-sensible vibration according to claim 1, wherein the vibration transfer unit is included in the housing portion of the sound generating unit, and the housing portion of the sound generating unit is connected to the housing portion of the vibration generating unit by a bridge.

5. The small-sized sound receiver for producing body-sensible vibration according to claim 1, wherein the vibration transfer unit is the housing portion of the sound generating unit, and the housing portion of the sound generating unit is in direct contact with the housing portion of the vibration generating unit.

6. The small-sized sound receiver for producing body-sensible vibration according to claim 1, wherein the vibration transfer unit is included in the housing portion of the sound generating unit, and the housing portion of the sound generating unit is connected to the housing portion of the vibration generating unit by a Bluetooth headset.

7. The small-sized sound receiver for producing body-sensible vibration according to claim 1, wherein the vibration transfer unit is made from a material which can maintain a bone-conduction sound pressure by at least 50%.

8. The small-sized sound receiver for producing body-sensible vibration according to claim 1, wherein the vibration transfer unit includes a central magnet and a magnetic body, the central magnet being positioned at a center part of the vibration transfer unit, the magnetic body being positioned at a peripheral surface of the central magnet, the magnetic body being bent and extending from the protecting member supporting the central magnet.
